(19) United States
(12) Patent Application Publication
(10) Pub. No.: US 2021/0367294 A1
(43) Pub. Date: Nov. 25, 2021

(54) BATTERY CELL

(71) Applicant: HONDA MOTOR CO., LTD., Tokyo (JP)

(72) Inventors: Takuya TANIUCHI, Saitama (JP); Masahiro OHTA, Saitama (JP); Toshiyuki ARIGA, Saitama (JP)

(21) Appl. No.: 17/320,227

(22) Filed: May 14, 2021

(30) Foreign Application Priority Data
May 19, 2020 (JP) 2020-087101

(51) Int. Cl. H01M 50/103; H01M 50/533; H01M 50/183; H01M 50/543

(52) U.S. Cl. CPC H01M 50/103; H01M 50/543; H01M 50/183; H01M 50/533

(57) ABSTRACT

To efficiently stack battery cells without shifting of the positions of the battery cells from each other in view of the above-described problems on module formation from the battery cells.

When the battery cells are stacked to form a module, the extension portion 22c of the exterior body of the battery cell 2 extending from the side surface of the battery on the side from which the collection tab lead does not extend is joined onto a side surface 22a, from which a collection tab lead does not extend, of an adjacent battery cell.

This application is based on and claims the benefit of priority from Japanese Patent Application 2020-087101, filed on 19 May 2020, the content of which is incorporated herein by reference.

### BACKGROUND OF THE INVENTION

### Field of the Invention

The present invention relates to a battery cell, and particularly relates to a battery cell sealed by an exterior body.

### Related Art

In recent years, a demand for high-capacity high-output battery devices has rapidly grown due to popularization of various types of electric/electronic equipment with a variety of sizes, such as an automobile, a personal computer, and a mobile phone. Examples of these battery devices include a liquid battery cell using, as an electrolyte, an organic electrolytic solution between positive and negative electrodes and a solid-state battery cell using a fire-retardant solid electrolyte instead of using the organic electrolytic solution as the electrolyte.

For these battery devices, a laminated cell type battery cell configured such that a battery is sealed in a plate shape with the battery being covered with a laminated film (an exterior body) is known. For a purpose such as an EV or an HEV, a battery cell assembly configured such that multiple laminated cell type battery cells as described above are arranged and housed in a case has been used. The battery is covered with the exterior body so that entry of atmospheric air into the battery can be prevented (e.g., Japanese Unexamined Patent Application, Publication No. 2012-169204). Note that in the present specification, the “battery” indicates a member including a battery element stack having positive and negative electrodes and an electrolyte and a collection tab lead, and one sealed with a battery being covered with a laminated film (an exterior body) will be referred to as a “battery cell”.

For the purpose of effectively improving the volume energy density of a battery module while maintaining sealability of a laminated film (an exterior body), a battery cell including an exterior body configured such that a single film is folded to house a battery is disclosed (WO2019/188825). According to WO2019/188825, this battery cell can effectively improve the volume energy density of the battery module while maintaining the sealability of the exterior body.
Patent Document 1: Japanese Unexamined Patent Application, Publication No. 2012-169204
Patent Document 2: WO2019/188825

### SUMMARY OF THE INVENTION

It has been difficult to efficiently stack the battery cells without shifting of the positions of the battery cells from each other upon module formation from the battery cells. When the positional shift is caused upon stacking of the battery cells, an equal surface pressure (binding force) cannot be applied to the battery cells, and the battery cells might be damaged due to a partially-excessive load.

The present invention has been made in view of the above-described problems on module formation from the battery cells, and an object of the present invention is to efficiently stack the battery cells without shifting of the positions of the battery cells from each other.

For solving the above-described problems, the battery cell of the present invention is a battery cell including a battery and an exterior body housing the battery. A collection tab lead is provided to extend from an end surface of the battery in a direction vertical to the end surface. The exterior body has a portion extending from a side surface, from which the collection tab lead does not extend, of the battery in a direction horizontal to the side surface. When the battery cells are stacked to form a module, the portion of the exterior body of the battery cell extending from the side surface of the battery is joined onto a side surface of an adjacent battery cell.

The exterior body has the portion extending from the side surface, from which the collection tab lead does not extend, of the battery. When the battery cells are stacked to form the module, the portion of the exterior body extending from the side surface from which the collection tab lead does not extend is joined onto the side surface of the adjacent battery cell. With this configuration, when the battery cells are stacked, a positional relationship between the battery cells is fixed, and positional shift due to slippage is not caused. Thus, the battery is not damaged due to a partially-excessive load caused by the positional shift.

In the present invention, in this case, the portion of the exterior body extending from the side surface has the same shape/dimensions as those of the side surface of the adjacent battery cell.

The portion of the exterior body extending from the side surface has the same shape/dimensions as those of the side surface of the adjacent battery cell. With this configuration, an uneven portion (a step) due to a portion extending from the side surface of the adjacent battery cell is not caused at the side surface of the battery cell, and damage on the embedded battery due to such an uneven portion can be avoided. Moreover, projection of the portion of the exterior body extending from the side surface of the adjacent battery cell and an adverse effect of such a projecting portion on a further adjacent battery cell can be avoided.

In the present invention, in this case, when the battery cells are stacked to form the module, a welding portion between the portion extending from the side surface and the side surface of the adjacent battery cell is vertically and alternately arranged at the battery cells stacked in the horizontal direction.

The side surface on the side opposite to the welding portion is covered with two film layers when the battery is packaged with the battery being covered with a film of the exterior body. The side surface on the welding portion side is covered with two films including a film of the portion extending from the adjacent battery cell. With this configuration, all side surfaces of the batteries of the stacked battery cells are protected by two films.

In the present invention, in this case, the exterior body is formed from a single film having the portion extending from the side surface.

The exterior body is formed from the single film. With this configuration, joint portions upon packaging can be reduced as much as possible, and sealability can be enhanced. The single film of the exterior body has the portion extending from the side surface from which the collection tab lead does not extend. With this configuration, when the battery is packaged with the battery being covered with the single film, the portion extending from the side surface of the battery cell is naturally formed, and therefore, a manufacturing efficiency can be enhanced.

In the present invention, in this case, the battery is an all-solid-state battery including a stack with a solid electrolyte.

The all-solid-state battery cell is brittle and easily damaged. For this reason, the configuration of the present invention for avoiding positional shift by fixing a positional relationship between the battery cells upon stacking of the battery cells and avoiding damage of the batteries due to a partially-excessive load caused by the positional shift is particularly effective for application to the all-solid-state battery cell.

As described above, the present invention fixes the positional relationship between the battery cells when the battery cells are stacked to form the module, thereby avoiding the positional shift. Thus, an equal surface pressure (binding force) can be applied to the battery cells, and therefore, damage of the batteries due to the partially-excessive load caused by the positional shift can be avoided.

### BRIEF DESCRIPTION OF THE DRAWINGS

FIG. 1 is a perspective view of a battery in a battery cell of the present invention;

FIG. 2 is a perspective view showing an outer appearance of the battery cell of the present invention;

FIG. 3 is a development view of an exterior body of the battery cell of the present invention; and

FIG. 4 is a sectional view of the stacked battery cells of the present invention.

### DETAILED DESCRIPTION OF THE INVENTION

Hereinafter, one embodiment of the present invention will be described in detail with reference to the drawings.

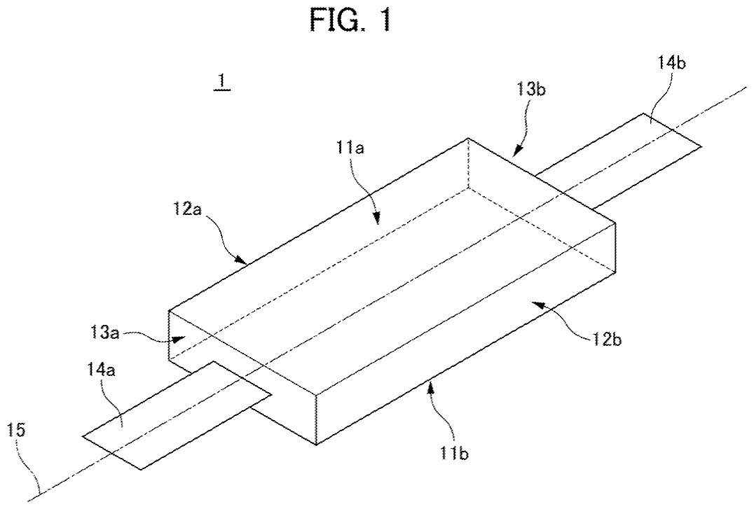

A battery 1 of the present invention is an all-solid-state battery in the embodiment, and is in a rectangular parallelepiped shape as shown in FIG. 1. The battery 1 has six surfaces including a top surface 11a, a bottom surface 11b, side surfaces 12a, 12b, and end surfaces 13a, 13b. Assuming a center axis 15 connects the centers of the end surfaces 13a, 13b to each other, each of collection tab leads 14a, 14b is provided to extend in the direction of the center axis 15 from a corresponding one of the end surfaces 13a, 13b. The all-solid-state battery is brittle and easily damaged particularly at a corner portion and a surface portion (an end surface portion), and for this reason, is more suitable for application of the configuration of each embodiment of the present invention.

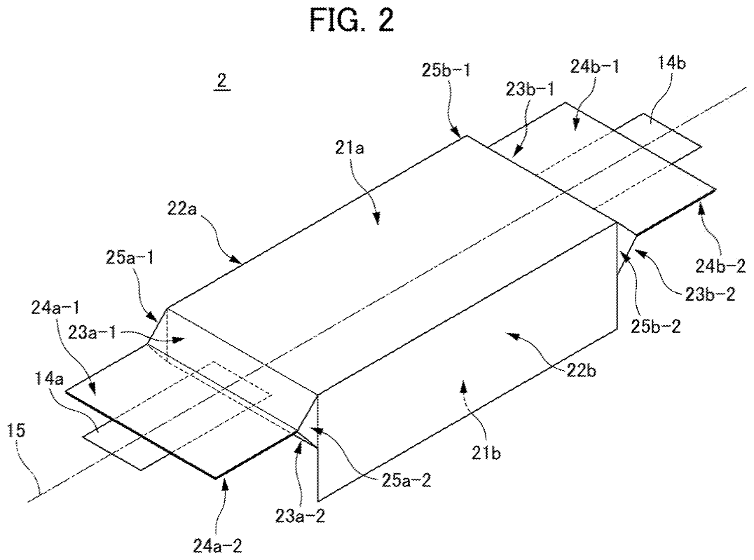

FIG. 2 shows a battery cell 2 configured such that the battery 1 of the present invention is packaged in an exterior body 3 with the battery 1 being covered with the exterior body 3. In the battery cell 2 of the present embodiment, a top surface 21a, a bottom surface 21b, and side surfaces 22a, 22b are defined corresponding to the battery 1. The side surface 22b described herein has an extension portion of the exterior body 3 extending beyond the bottom surface 21b in the plane of the side surface 22b, and in FIG. 2, the exterior body 3 extends lower than the bottom surface 21b. Normally, the battery cells 2 to be stacked adjacent to each other have the same dimensions/shape, and therefore, the extension portion of the side surface 22b has the same shape/dimensions as those of a portion which is not the extension portion of the side surface 22b of the battery cell 2. That is, the area of the exterior body 3 on a side surface 22b side is a size twice as large as the area of the exterior body 3 on an opposite side surface 22a side.

Portions corresponding to the end surfaces 13a, 13b of the battery 1 are end surface folding portions 23a-1, 23a-2, 23b-1, 23b-2 in such a form that the exterior body 3 is folded, and have appearances in a triangular prism shape. At the end surface folding portions 23a-1, 23a-2, 23b-1, 23b-2, the total of four triangular pyramid-shaped spaces 25a-1, 25a-2, 25b-1, 25b-2 formed by folding-in of the portions 23a-1, 23a-2, 23b-1, 23b-2 from the side surface 22a, 22b sides are formed two on each side. Collection tab lead housing portions 24a-1, 24a-2, 24b-1, 24b-2 vertically sandwiching and housing the collection tab leads 14a, 14b are provided to extend in the center axis 15 direction from tip end sides of the end surface folding portions 23a-1, 23a-2, 23b-1, 23b-2.

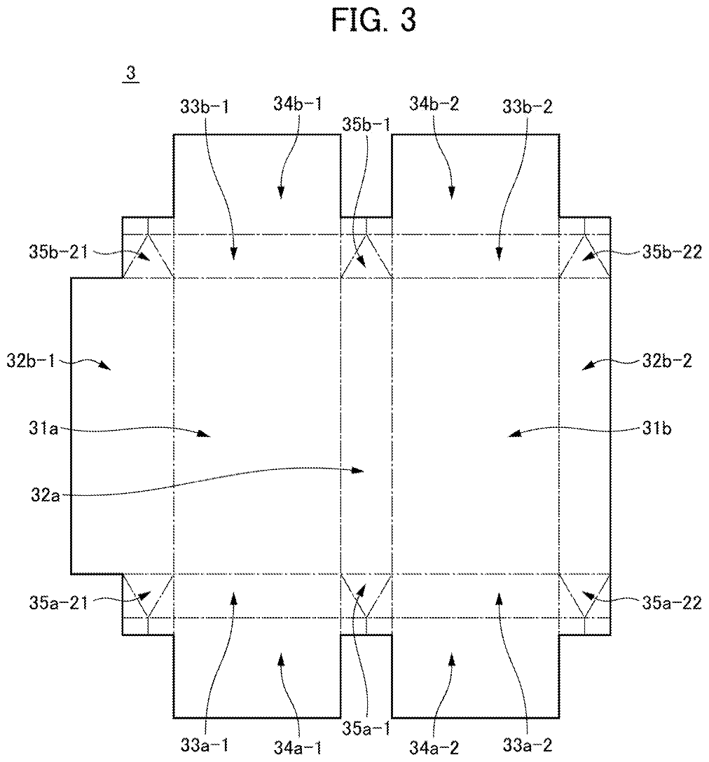

FIG. 3 shows a development view of the exterior body 3. The exterior body 3 has a top surface covering portion 31a and a bottom surface covering portion 31b as portions each covering the top surface 11a and the bottom surface 31b of the battery 1, has a side surface covering portion 32a as a portion covering the side surface 12a, and has side surface covering portions 32b-1, 32b-2 as portions covering the side surface 12b. The side surface covering portions 32b-1, 32b-2 are joint portions overlapping with and joined to each other when the battery 1 is covered with the exterior body 3. Thus, the side surface 22b of the battery cell 2 is configured such that the side surface 12b of the battery 1 is doubly covered with the side surface covering portions 32b-1, 32b-2 of the exterior body 3.

As portions covering the end surfaces 13a, 13b of the battery 1, end surface covering portions 33a-1, 33a-2, 33b-1, 33b-2 which are portions forming the triangular prism-shaped end surface folding portions 23a-1, 23a-2, 23b-1, 23b-2 of the battery cell 2 in the form that the exterior body 3 is folded are provided corresponding to an upper-lower direction of the end surface on each side. As extensions of the end surface covering portions 33a-1, 33a-2, 33b-1, 33b-2 in the center axis 15 direction, collection tab lead sandwiching portions 34a-1, 34a-2, 34b-1, 34b-2 vertically sandwiching the collection tab leads on both sides are provided. As portions forming the triangular pyramid-shaped spaces 25a-1, 25a-2, 25b-1, 25b-2 formed folded in from the side surface 22a, 22b sides, triangular pyramid-shaped space formation portions 35a-1, 35a-21, 35a-22, 35b-1, 35b-21, 35b-22 are formed. The triangular pyramid-shaped space formation portions 35a-21, 35a-22 overlap with each other to form the triangular pyramid-shaped space, and the triangular pyramid-shaped space formation portions 35b-21, 35b-22 overlap with each other to form the triangular pyramid-shaped space.

In the present embodiment, the side surface covering portion 32b-1 of the exterior body 3 outwardly (leftward in FIG. 3) extends with respect to the triangular pyramid-shaped space formation portions 35a-21, 35b-21 as shown in FIG. 3.

The extension portion of the side surface covering portion 32b-1 of the exterior body 3 is a portion forming the extension portion of the side surface 22b of the battery cell 2, and is provided with the same shape/dimensions as those of the side surface 22a of the adjacent battery cell 2 because the battery cells 2 to be stacked adjacent to each other normally have the same dimensions/shapes. Thus, the extension portion of the side surface covering portion 32b-1 has the same shape/dimensions as those of the non-extension portion of the side surface covering portion 32b-1 and those of the side surface covering portions 32a, 32b-2.

As described above, in the embodiment of the present invention, the extension portion of the exterior body 3 extending from the side surface covering portion 32b-2 is integrally formed from a single film, and therefore, joint portions upon packaging can be reduced as much as possible and sealability can be enhanced. In addition, when the battery 1 is packaged with the battery 1 being covered with the single film of the exterior body 3, the extension portion of the exterior body 3 corresponding to the side surface 22b of the battery cell 2 is naturally formed in a manufacturing process, and therefore, a manufacturing efficiency is high.

In one embodiment of the present invention, when the battery cells 2 are stacked in the horizontal direction to form a module, an inner surface portion of the extension portion 22c of the exterior body 3 of the battery cell 2 is surface-joined to an outer surface portion of the side surface 22a of the adjacent battery cell 2 by welding. By such welding, slippage between the battery cells 2 is prevented, and the battery cells 2 are bound to each other. Thus, an equal surface pressure is on the surfaces of the battery cells 2, and therefore, an uneven load due to shifting of the positions of the adjacent battery cells 2 from each other can be avoided. Thus, there is no probability that the battery cells 2 are damaged by an excessive load due to shifting of the positions of the adjacent battery cells 2 from each other.

The extension portion 22c of the exterior body 3 of the battery cell 2 preferably has the same shape/dimensions as those of the side surface 22a of the adjacent battery cell 2. If these portions have different shapes/dimensions, the side surfaces 22a, 22b of the battery cells 2 form an uneven portion due to such a shape/dimension difference. For this reason, an uneven load is on the side surfaces 22a, 22b, and there is a high probability that the battery cells 2 are damaged due to an excessive load. Specifically, in a case where the extension portion 22c is smaller than the side surface 22a, if the battery cells 2 are fixed using a module component, the extension portion 22c does not cover the entirety of the side surface 22a of the adjacent battery cell 2. For this reason, at the side surfaces 12a, 12b of the battery 1, there are a portion to which a fixed pressure is applied and a portion to which no fixed pressure is applied. Thus, electrodes are damaged due to a non-uniform load. In a case where the extension portion 22c is larger than the side surface 22a, if the battery cells 2 are fixed using the module component, the extension portion 22c covers part of the side surface 22a of the battery cell 2 further adjacent to the adjacent battery cell 2. For this reason, at the side surfaces 12a, 12b of the battery 1, there is a portion to which a fixed pressure higher than a normal pressure is applied. Thus, the electrodes are damaged due to a non-uniform load. Further, in a case where the extension portion 22c is larger than the side surface 22a, not only damage by the projecting portion but also a problem leading to a module energy density decrease due to the presence of an extra portion are caused.

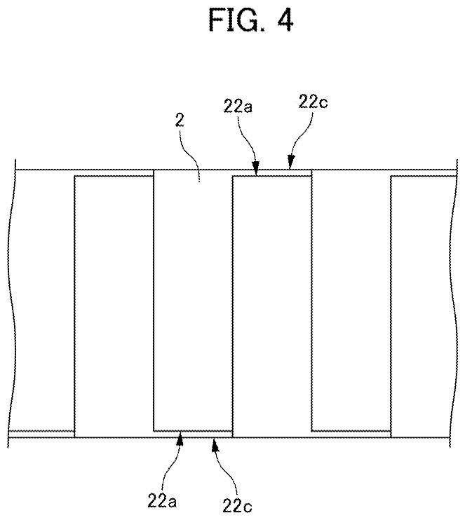

As can be seen from FIG. 4, when the battery cells 2 are sequentially stacked in the horizontal direction in the above-described manner, welding portions at each of which an inner surface of the extension portion 22c of the exterior body 3 of the battery cell 2 and the side surface of the adjacent battery cell are welded to each other are vertically and alternately arranged in the horizontal direction of the stack.

In this case, the side surface of the battery on the side opposite to the welding portion is covered with two layers formed by the film of the exterior body 3 when the battery is packaged with the battery being covered with the film of the exterior body. The side surface on the welding portion side is covered with two films of the exterior bodies 3 including the film of the portion extending from the adjacent battery cell 2. With this configuration, all side surfaces of the batteries of the stacked battery cells are protected by two films. Note that a top surface 21a side and a bottom surface 21b side of the battery cell 2 contact a bottom surface 21b side and a top surface 21a side of the adjacent battery cell 2 through the single film of the exterior body 3, and these battery cells 2 protect each other from external forces. Thus, the stack of the battery cells 2 forming the module is in such a form that the entirety of the stack is strongly protected from the external forces.

The all-solid-state battery cell described herein has a disadvantage that the all-solid-state battery cell is brittle and easily damaged at the surface, and has an underlying technical problem that such a cell needs to be strongly protected. For this reason, the configuration of the present invention for avoiding positional shift by fixing a positional relationship among the battery cells upon stacking of the battery cells and avoiding damage of the batteries due to a partially-excessive load caused by the positional shift and the configuration of the present invention for doubly covering the entire side surfaces with the films of the exterior bodies upon module formation to provide strong protection are particularly effective for application to the all-solid-state battery cell.

The embodiment of the present invention has been described above with reference to the example, but the present invention is not limited to such an example. Needless to say, various forms can be made without departing from the gist of the present invention.

### EXPLANATION OF REFERENCE NUMERALS

1 Battery
11a Top Surface
11b Bottom Surface
12a, 12b Side Surface
13a, 13b End Surface
14a, 14b Collection Tab Lead
15 Center Axis
2 Battery Cell
21a Top Surface
21b Bottom Surface
22a, 22b Side Surface
22c Extension Portion of Exterior Body
23a-1, 23a-2, 23b-1, 23b-2 End Surface Folding Portion
24a-1, 24a-2, 24b-1, 24b-2 Collection Tab Lead Housing Portion
25a-1, 25a-2, 25b-1, 25b-2 Triangular Pyramid-Shaped Space
3 Exterior Body
31a Top Surface Covering Portion
31b Bottom Surface Covering Portion
32a, 32b-1, 32b-2 Side Surface Covering Portion
33a-1, 33a-2, 33b-1, 33b-2 End Surface Covering Portion
34a-1, 34a-2, 34b-1, 34b-2 Collection Tab Lead Sandwiching Portion
35a-1, 35a-21, 35a-22, 35b-1, 35b-21, 35b-22 Triangular Pyramid-Shaped Space Formation Portion

What is claimed is:

1. A battery cell comprising:
a battery; and
an exterior body housing the battery,
wherein a collection tab lead is provided to extend from an end surface of the battery in a direction vertical to the end surface,
the exterior body has a portion extending from a side surface, from which the collection tab lead does not extend, of the battery in a direction horizontal to the side surface, and
when battery cells are stacked to form a module, the portion of the exterior body of the battery cell extending from the side surface of the battery is joined onto a side surface of an adjacent battery cell.

2. The battery cell according to claim 1, wherein the portion of the exterior body extending from the side surface has a shape/dimension identical to that of the side surface of the adjacent battery cell.

3. The battery cell according to claim 1, wherein when the battery cells are stacked to form the module, a joint portion between the portion of the exterior body extending from the side surface and the side surface of the adjacent battery cell is vertically and alternately arranged at the battery cells stacked in the horizontal direction.

4. The battery cell according to claim 1, wherein the exterior body is formed from a single film having the portion extending from the side surface.

5. The battery cell according to claim 1, wherein the battery is an all-solid-state battery including a stack with a solid electrolyte.
